(19) United States
(12) Patent Application Publication
(10) Pub. No.: US 2026/0295911 A1
(43) Pub. Date: Oct. 1, 2026

(54) METHOD FOR PRODUCING A CLOSURE CAP FOR CONTAINERS

(71) Applicant: GEORG MENSHEN GMBH & CO. KG, FINNENTROP (DE)

(72) Inventors: TIM GIERSE, ATTENDORN (DE); CHRISTOPH CZARNETZKI, FINNENTROP (DE)

(73) Assignee: GEORG MENSHEN GMBH & CO. KG, FINNENTROP (DE)

(21) Appl. No.: 19/477,111

(22) PCT Filed: Mar. 27, 2024
(86) PCT No.: PCT/EP2024/058178

§ 371 Date: Oct. 21, 2025

(30) Foreign Application Priority Data
Apr. 27, 2023 (DE) 10 2023 110 959.6

(51) Int. Cl. B29C 45/14; B29C 45/26; B29L 31/56; B65D 41/34

(52) U.S. Cl. CPC B29C 45/1418; B29C 45/2618; B65D 41/3457; B29L 2031/565

(57) ABSTRACT

A method for producing a closure cap for a container includes providing an injection molding tool where a casing tool engages over a core tool. The core tool and the casing tool form a volume region when the injection molding tool is closed. The core tool has an axial end surface in which a recess is formed. The casing tool has a projection with a gate opening. The axial end surface and the inner axial end surface are arranged opposite each other. An insert element is positioned between the axial end surface and the inner axial end surface. The injection molding tool is closed so that the projection at least partially penetrates into the recess, thereby deforming the insert element. The volume region is filled with a molten plastic through the gate opening. The insert element is thereby pressed against the axial end surface by the molten plastic.

### CROSS REFERENCE TO PRIOR APPLICATIONS

This application is a U.S. National Phase application under 35 U.S.C. § 371 of International Application No. PCT/EP2024/058178, filed on Mar. 27, 2024 and which claims benefit to German Patent Application No. 10 2023 110 959.6, filed on Apr. 27, 2023. The International Application was published in German on Oct. 31, 2024 as WO 2024/223191 A1 under PCT Article 21(2).

### FIELD

The present invention relates to a method for producing a closure cap for containers with an injection molding tool comprising at least one core tool and at least one casing tool which engages over the core tool, both of which tools are formed around a common center axis and, in the closed state of the injection molding tool, form between them a volume region which defines the closure cap and into which molten plastic is injected. The present invention also relates to a closure cap produced via the method.

### BACKGROUND

Both in the prior art and in the present invention, an injection molding tool can, for example, be closed by virtue of the at least one core tool being introduced into the casing tool in the direction of the common center axis until these two tools assume a predetermined desired axial distance from one another. Both in the prior art and in the present invention, opening can, for example, be performed in the reverse direction in order to demold the closure cap produced, wherein a rotation of the casing tool around the common center axis may be provided, for example, if a closure cap has been produced which has an internal thread and for this purpose the core tool has a corresponding thread or corresponding thread portions on its radially outwardly facing lateral surface.

Methods for producing container closure caps via plastic injection molding in an injection molding tool have previously been described, for example, in EP 4144662 A1. The closure caps thus produced can be used for a large number of different containers.

The requirements placed on a closure cap is high in the technical field of containers, for example, those made of glass or plastic, for example, bottles or canisters, in particular those intended for chemical substances to which the present invention can, for example, also relate.

Closure caps must, for example, close the containers tightly, be sufficiently stable, in particular in order not to break even in the event of a fall of the container, and must not only protect the contents of the container from substances in the environment but also protect the environment from substances from the contents of such containers. These specifications are often not complied with by conventional closure caps.

### SUMMARY

An aspect of the present invention is to further develop a method for producing a closure cap of the type stated above so that a safe and stable closure cap is provided via the method.

In an embodiment, the present invention provides a method for producing a closure cap for a container. The method includes providing an injection molding tool comprising at least one core tool and at least one casing tool which is configured to engage over the at least one core tool. Each of the at least one core tool and the at least one casing tool are formed around a common center axis and, in a closed state of the injection molding tool, form between them a volume region which defines the closure cap. The at least one core tool comprises an axial end surface in which a recess surrounding the center axis is formed. The at least one casing tool comprises, on an inner axial end surface, a projection which surrounds the center axis. The axial end surface of the at least one core tool and the inner axial end surface of the at least one casing tool are arranged mutually opposite to each other. The projection of the at least one casing tool comprises a gate opening. An insert element is positioned between the axial end surface of the at least one core tool and the inner axial end surface of the at least one casing tool. The injection molding tool is closed so that the projection of the at least one casing tool at least partially penetrates into the recess of the at least one core tool so as to thereby deform the insert element. After closing the injection molding tool, an injection molding is performed by filling the volume region with a molten plastic through the gate opening positioned in the projection so that the insert element is pressed against the axial end surface of the at least one core tool by the molten plastic from a direction of the at least one casing tool.

### BRIEF DESCRIPTION OF THE DRAWINGS

The present invention is described in greater detail below on the basis of embodiments and of the drawings in which:

FIG. 1 shows a perspective view of a sectional representation of an arrangement of all essential components for carrying out the method to produce a closure cap of the present invention;

FIG. 2 shows the complete engagement of the lower partial ring in the annular gap so that the upper partial ring closes the axially open side of the annular gap, and that the insert element lies on the annular surface of the axial end surface, which surrounds a recess in the axial end surface;

FIG. 3 shows the arrangement of the elements of FIG. 1 in a closed state of the injection molding tool;

FIG. 4 shows A an embodiment of the core tool in which the annular surface of the axial end surface is designed to be regionally flat and transitions into the recess radially inwardly and into the lateral surface of the core tool radially outwardly, for example, being rounded in each case, and B, an arrangement of the deformed insert element which is pressed by plastic onto the core tool (without illustrating the plastic);

FIG. 5 shows the actual injection molding process in which liquid plastic is injected through the gate opening into the volume region;

FIG. 6 shows the closure cap produced via the method of the present invention;

FIG. 7 shows the annular projection on the produced closure cap;

FIG. 8 shows a closed arrangement of an injection molding tool which comprises radially movable casing tools with radial pins to form the openings which is used to produce a tamper-evident ring; and

FIG. 9 shows the arrangement of FIG. 8 when the injection molding tool, and radially movable casing tools with radial pins, have been radially opened to remove a manufactured tamper-evident ring.

### DETAILED DESCRIPTION

The present invention provides a core tool which has an axial end surface in which a recess surrounding the center axis is formed, and a casing tool which has, on its inner axial end surface, a projection surrounding the center axis, wherein, before closing the injection molding tool, an insert element, for example, a planar insert element, for example, a circular disc-shaped insert element, is positioned between the two mutually opposite axial end surfaces, and, when closing the injection molding tool, the projection at least partially penetrates into the recess and thereby deforms the insert element, and, after closing the injection molding tool, the volume region is filled with molten plastic through a gate opening positioned in the projection, for example, on the center axis, whereby the insert element is pressed against the axial end surface of the core tool by the plastic from the direction of the casing tool.

The closing of the injection molding tool can, for example, be performed by a linear movement between the core tool and the casing tool/outer tool, for example, without a rotation of the two tools with respect to one another, however, a rotation can also be provided during closing, for example, to bring the two tools into a desired angular position with respect to one another.

The aforementioned recess can, for example, be surrounded by an annular surface, for example, a regionally flat annular surface. The recess can, for example, have a bottom surface, in particular a flat bottom surface at least regionally, which is offset from the annular surface in the axial direction around the depth of the recess. The axial direction in this description of the present invention is generally the direction of the common center axis or parallel thereto.

The axial, in particular inner end surface of the casing tool is opposite the axial end surface of the core tool in the closed state of the injection molding tool with the formation of a distance, wherein the previously not yet deformed, for example, flat/planar insert element lies in this distance region.

As a result of the deformation, the insert element, for example, the initially planar insert element, is preformed in the direction of the final shape, in particular at least preformed substantially in a pot-or dish-shaped manner, in particular preformed in the sense that, as a result of the deformation, the insert element approaches the end shape except for the clearance in the distance region between the two tools.

The procedure according to the present invention provides that the insert element is covered only on one side by plastic from the direction of the casing tool, but is exposed in the thus produced closure cap in its interior, in particular with contact to the contents of a container which is to be closed with the closure cap.

The recess is here formed in the axial end surface of the core tool so that a projection protruding from the cap cover on the inside is thereby formed in the produced cap, which projection penetrates axially into the interior of the container neck when the container is closed with the cap. Such a projection can thus, for example, form a plug arranged on the cap cover region, which plug also performs a sealing function with respect to the inner wall region of the container neck in the radial direction. The sealing is here achieved via the insert element which covers the plug thereby formed. The initially mentioned annular surface of the end surface of the core tool forms a collar in the insert element formed in a pot-or dish-shaped manner, in particular a radially outwardly lying collar which covers the annular end surface of the container neck when closing a container.

The closure cap produced according to the present invention thus has an extended sealing function compared with the prior art.

The projection in the casing tool can, for example, be further formed so that a recess is formed on the outside in the produced closure cap, for example, in the middle of which the gate point is located. The closure cap cover is as a result given a shape which deviates from the purely planar shape, in particular a pot-or dish-shaped shape with a radially outer edge on the cover region which transitions into the at least substantially axially extending lateral surface of the closure cap. This shape design leads to increased stability of the closure cap, in particular in the cover region which covers the container neck opening, and thus also to improved tightness.

In the case of a closure cap produced according to the present invention, the insert element can, for example, be the only element of the closure cap which can come into contact with the contents of the container. The insert element can thus not only perform a sealing function but also form a diffusion barrier for the contents of the container against diffusion of the contents to the outside and also against diffusion of ambient substances, for example, oxygen, to the inside into the container.

The closure cap according to the present invention thus achieves a plurality of advantages by combining a deformed insert element with a cover region formed to provide an inner plug.

The present invention may provide that the closure cap is always produced with the same plastic during injection molding, for example, from polyethylene (PE) or polypropylene (PP), although the present invention is not limited to these plastics.

It may also additionally be provided that, depending on the area of application of the closure cap to be produced, the material of the insert element coming into contact with the container contents is selected depending on the intended container contents.

It can, for example, be provided that the insert element is selected from a fluoropolymer, in particular is selected from one of the following materials: perfluoroalkoxy (PFA), ethylene-tetrafluoroethylene (ETFE), ethylene-chlorotrifluoroethylene (ECTFE), polyvinylidene fluoride (PVDF), and polytetrafluoroethylene (PTFE). Such fluoropolymers have the advantage of being resistant to many chemicals and in particular of being poorly wetted by liquid chemicals so that only minimal amounts of the container contents can remain in the interior of the closure cap, in particular on the insert element.

The present invention can generally provide that the insert element is selected from a material to which the plastic does not bond materially during injection molding; according to the present invention, the insert element is then in particular held in the cap exclusively in a form-fitting and/or force-fitting manner.

Not only does the plastic adhere poorly during injection molding to such materials, for example, the fluoropolymers mentioned above, but (as mentioned) the container contents then also advantageously adhere similarly poorly. The form-fitting holding nevertheless provides a permanent position of the insert element in the closure cap.

Due to the deformation of the insert element and the contacting of the injected plastic, a form fit between the insert element and the injected solidified plastic is achieved in the shaping according to the present invention both in axially and radially oriented surface regions of the cover region of the closure cap, in particular a form fit of the solidified injection plastic with one of the two, for example, initially planar surfaces of the insert element which are deformed according to the present invention and which are situated opposite one another over the thickness of the insert element. A form fit can, for example, also be achieved between the radially outer edge surface of the originally non-deformed insert element, for example, planar insert element, and the solidified injection plastic, in particular whereby a peeling of the insert element close to the edge from the solidified injection plastic is prevented.

An embodiment of the present invention provides that the circular disc diameter of the insert element can, for example, be selected to be larger or smaller than the outside diameter of the axial end surface, in particular than the outside diameter of the annular surface surrounding the recess, for example, the regionally flat annular surface of the axial end surface of the core tool, so that, with the penetration of the projection into the recess and/or as a result of pressing with the plastic, the radially outwardly facing edge surface of the insert element comes to lie on the axial end surface, in particular on the annular surface surrounding the recess, for example, the regionally flat annular surface of the axial end surface.

In this embodiment, the insert element can therefore, for example, be located exclusively axially in front of the axial end surface of the core tool after deformation without engaging around its lateral surface.

In an embodiment of the present invention, the circular disc diameter of the insert element can, for example, be selected to be larger than the outside diameter of the axial end surface, in particular than the outside diameter of the annular surface surrounding the recess, for example, the regionally flat annular surface of the axial end surface of the core tool, and that the core tool has in its lateral surface an annular surface beyond which the lateral surface, in cross section, in particular in its outside diameter, tapers in the direction of the axial end surface, wherein, by closing the injection molding tool and/or as a result of the pressing with the plastic, a radially outer edge region of the insert element is turned over onto the lateral surface in the axial direction, for example, wherein the radially outwardly facing edge surface of the originally non-deformed, for example, planar insert element contacts, in the turned-over state, in the axial direction, an annular projection which projects radially inwardly in the cap and which is formed by the plastic molded onto the annular surface.

The annular surface in the core tool can, for example, be formed axially over the last thread turn. The annular surface can, for example, form a step at which the tapering of the lateral surface occurs. The annular surface may be at least regionally or completely flat.

The annular surface can, for example, be formed to be radially outwardly concave, in particular rounded. The lateral surface of the core tool in this embodiment is thus covered by the insert element in the axial end region of the core tool.

In an embodiment of the present invention, which embodiment can be combined with all embodiment variants of the present invention, it is provided that the axial inner end surface of the casing tool can, for example, have radially extending channels, in particular the radial inner lateral surface of the casing tool also has axially extending channels, for example, wherein the channels of the axial end surface and the lateral surface merge into one another, wherein reinforcing ribs are formed by injection molding through the channels in the cover region and/or in the lateral region of the closure cap. This also further improves the stability of the closure cap in the cover region.

In an embodiment, the present invention can, for example, provide that, before closing the injection molding tool, a tamper-evident ring in two parts in the axial direction is arranged between the core element and the casing element and is connected radially inwardly to the closure cap by injection molding at the lower edge region surrounding the closure cap opening, in particular is connected at least in a form-fitting and force-fitting manner, for example, also in a materially bonded manner.

Such a ring is provided, for example, to indicate the first opening of a container which was closed with the closure cap according to the present invention. It can, for example, here be provided that one part of the two-part tamper-evident ring that is connected to the closure cap remains therein during opening and another part remains fastened around the container neck.

The method of the present invention can, for example, provide that the core tool comprises a core inner part which is coaxially surrounded by a first core sleeve which is coaxially surrounded by a second core sleeve, wherein between the core sleeves there is formed, in particular in the region of their respective axial ends, an annular gap which is open in the axial direction and into which the tamper-evident ring is inserted at least with an axially extending partial region.

The tamper-evident ring can, for example, here comprise a first partial ring and a second partial ring which are spaced apart in the axial direction by a gap and connected in the axial direction in a gap-bridging manner by axially extending breakable bridges, wherein the partial ring facing in the axial direction towards the axial end surface of the casing tool closes the annular gap between the core sleeves against the penetration of liquid plastic and is connected to the injected plastic with its surface facing into the volume region of the injection molding tool.

The gap between the partial rings and any openings or projections, in particular the shape previously formed in the other partial ring, thus remains shielded from the injected plastic and unaffected.

The aforementioned breakable bridges provide that the tamper-evident ring can be broken into the two partial rings during the opening process of a container so that a (lower) partial ring remains around the container neck and an (upper) partial ring remains in the closure cap.

The tamper-evident ring itself can, for example, be produced in an upstream step of injection molding, in particular from the same material from which the closure cap is formed.

In the upstream step of injection molding, radially inwardly extending projections and/or radially extending openings can, for example, be formed in the partial ring, which is shielded from plastic, of the tamper-evident ring, in particular via an injection molding tool comprising a multi-part casing tool whose parts are movable in the radial direction.

Embodiments of the present invention are explained in greater detail with reference to the drawings.

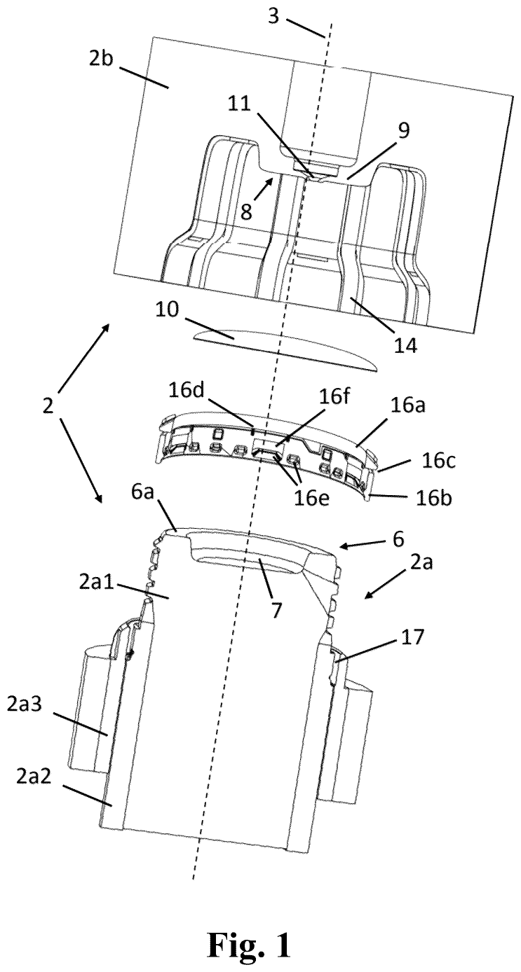

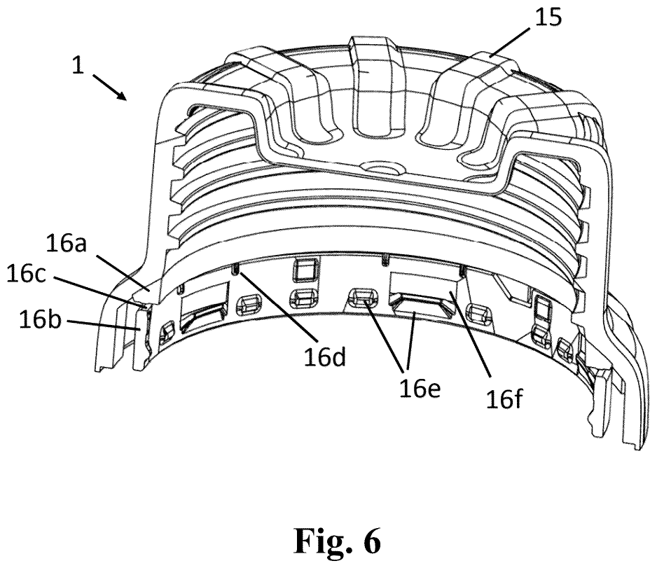

FIG. 1 shows a sectional representation of a perspectively illustrated arrangement of all essential components for carrying out the method to produce a closure cap 1, a sectional view of which is shown in FIG. 6.

The injection molding tool 2 comprises a core tool 2a, which has a core inner part 2a1, a first core sleeve 2a2 arranged coaxially around it, and a second core sleeve 2a3 arranged around it. The core sleeves 2a2 and 2a3 can, for example, be displaceable relative to the core inner part 2al axially parallel to the common center axis 3.

An axially displaceable ejector sleeve 2a4 can additionally be arranged on the outside coaxially around the second core sleeve 2a3, for example, to strip the closure cap 1 produced later from the second core sleeve 2a3.

An annular gap 17 is arranged between the core sleeves 2a2 and 2a3 which is open to the casing tool 2b in the axial direction and into which there can be inserted a tamper-evident ring 16 which is formed in two parts in the axial direction, an upper partial ring 16a and a lower partial ring 16b.

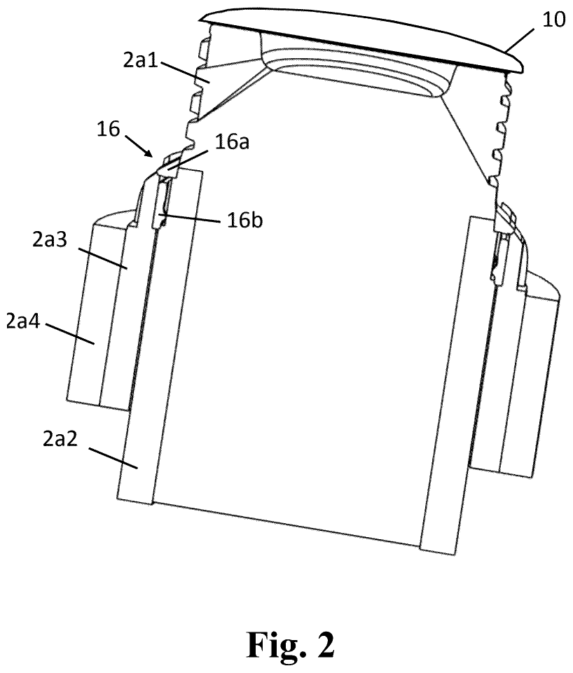

As shown in FIG. 2, the lower partial ring 16b can, for example, completely engage in the annular gap 17, wherein the upper partial ring 16a closes the axially open side of the annular gap 17.

In the open state of the injection molding tool 2, an insert element 10, here, for example, a planar/flat insert element 10 made, for example, from a fluoropolymer, is inserted axially between the axial end surface 6 of the core tool 2a and the axial end surface 8 of the casing tool 2b. FIG. 2 shows that the insert element 10 lies on the annular surface 6a of the axial end surface 6 which surrounds a recess 7 in the axial end surface 6. The recess 7 is here covered by the insert element 10. In the shown embodiment, the outside diameter of the insert element 10 can, for example, be greater than the outside diameter of the axial end surface 6 and/or than the outside diameter of the annular surface 6a. The outside diameter of the insert element 10 may, however, also be smaller than the outside diameter of the axial end surface 6 and/or than the outside diameter of the annular surface 6a.

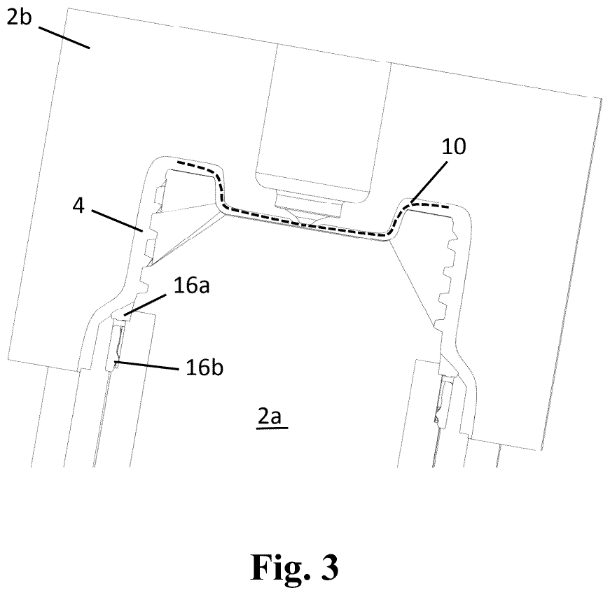

FIG. 3 shows the arrangement of the elements of FIG. 1 in a closed state of the injection molding tool 1. The core tool 2a here consisting of the core inner part 2a1, the core sleeves 2a2, 2a3, the ejector sleeve 2a4, and also the casing tool 2b, enclose a volume region 4 in which the closure cap 1 is formed by injection of liquid plastic.

FIG. 3 further shows that, by closing the injection molding tool 2, the originally non-deformed, for example, flat insert element 10 is pre-deformed in that the projection 9 at least partially engages in the recess 7, with the insert element 10 being contacted and here being carried along. This is similar to deforming the insert element 10 by thermoforming.

The insert element can here, for example, take any desired shape within the gap which is formed between the axial end surfaces 6 and 8.

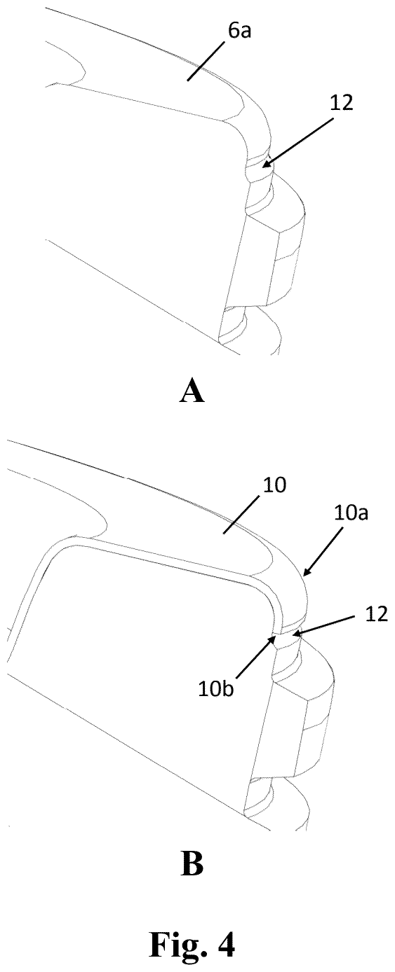

FIG. 4 A shows an embodiment of the core tool 2a in which the annular surface 6a of the axial end surface 6 is designed to be regionally flat and transitions into the recess radially inwardly and into the lateral surface of the core tool radially outwardly, for example, being rounded in each case.

The lateral surface has an annular surface 12 axially spaced apart from the annular surface 6a at which the lateral surface is tapered in diameter in the direction of the annular end surface 6a or the axial end surface 6. The annular surface 12 is here of a rounded design and thus forms a radially outwardly concave step. Other embodiments of the annular surface 12 are also possible, for example, ones which are flat or outwardly convex.

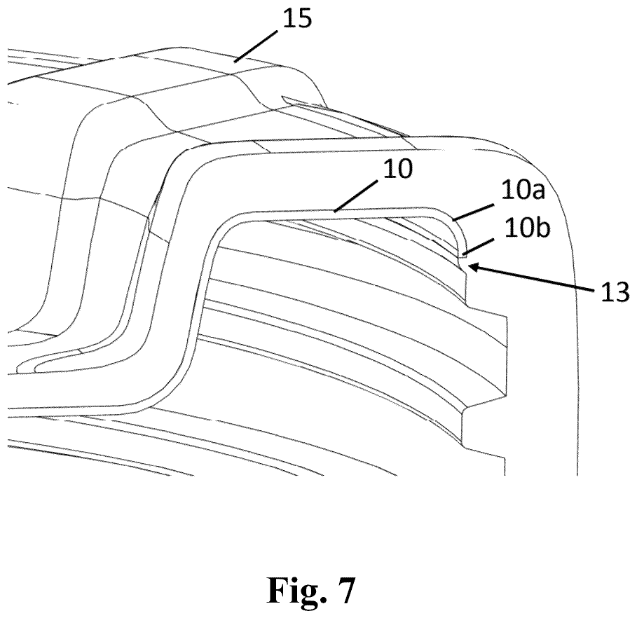

FIG. 4 B shows the arrangement of the deformed insert element 10 which is pressed by plastic onto the core tool 2a (without illustrating the plastic). It is here clear that plastic molded onto the annular surface 12 can form an annular projection 13 in the closure cap 1, which projection is form-fittingly adjoined in the axial direction by the edge 10b, which faces radially outwardly in the non-deformed state, of the radially outer edge region 10a of the insert element 10, which radially outer edge region 10a is turned over onto the lateral surface after the deformation. FIG. 7 shows this annular projection 13 on the produced cap.

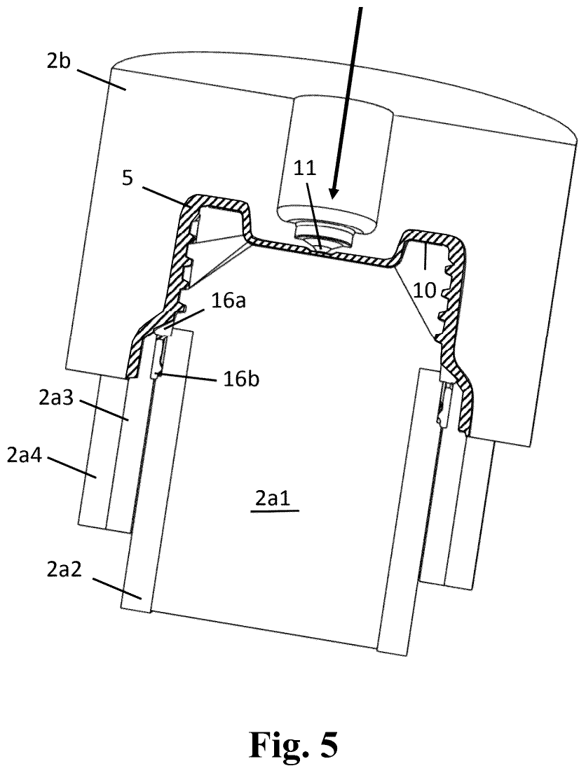

FIG. 5 illustrates the actual injection molding process in which liquid plastic 5, for example, polyethylene or polypropylene, is injected through the gate opening 11 into the volume region 4. From the side of the casing tool 2b, the plastic 5 here presses the insert element 10 onto the axial end surface 6 of the core tool 2a, or onto the surface of the recess 7 and on the annular surface 6a, wherein, starting at the gate opening 11, the plastic 5 fills the volume 4 first radially outwardly and then in the axial direction towards the tamper-evident ring 16. The injected plastic can bond, for example, materially, on that surface of the upper partial ring 16a of the tamper-evident ring 16 which faces into the volume region 4.

It may be provided that the plastic 5 does not bond materially with the contacted surface of the insert element 10 but is connected only in a form-fitting and/or force-fitting manner, in particular when a fluoropolymer has been selected as the material of the insert element.

If the outside diameter of the insert element 10 is greater than the outside diameter of the axial end surface 6, or greater than the diameter of its annular surface 6a, then the radially outer edge region 10a is turned over onto the lateral surface of the core tool 2a in the axial direction as shown in FIGS. 4 and 7.

In this embodiment, it may, for example, be provided that an annular surface 12 is arranged in the lateral surface of the core tool 2a, in particular of the inner core part, for example, over the last thread turn, wherein the molding of plastic onto the surface of the annular surface 12 leads to the formation of the annular projection 13, which is contacted in the axial direction by the radially outer edge region 10a of the insert element 10. By virtue of the embodiment according to the present invention, the insert element 10 is overall form-fittingly held by injected plastic in radial and axial surface regions so that, even without a material bond to the injection plastic, the insert element 10 is securely fixed in the closure cap 1.

FIG. 5 shows an embodiment in which, after the deformation and the pressing by plastic, the outside diameter of the insert element 10 is smaller than the outside diameter of the annular surface 6a or than the outside diameter of the axial end surface 6, so that the insert element 10 lies on the annular surface 6a and does not cover the lateral surface.

FIG. 7 further shows the formation of reinforcing ribs 15 which extend in the radial direction on the cover region and in the axial direction on the lateral region of the closure cap 1 and are formed by corresponding channels 14 in the inner surface of the casing tool.

FIG. 6 further illustrates the, for example, material bonding of the tamper-evident ring 16 with its upper partial ring 16a in the lower open edge region of the closure cap 1, in particular at a region of the closure cap 1 where the cap casing widens radially outwards.

The upper partial ring 16a is spaced apart from the lower partial ring 16b with the formation of a gap 16c, but is here connected thereto by axially extending breakable bridges 16d. In the lower partial ring 16b, radially inwardly protruding projections 16e are further provided and can engage behind an annular projection on the container neck, and also radially extending openings 16f are formed.

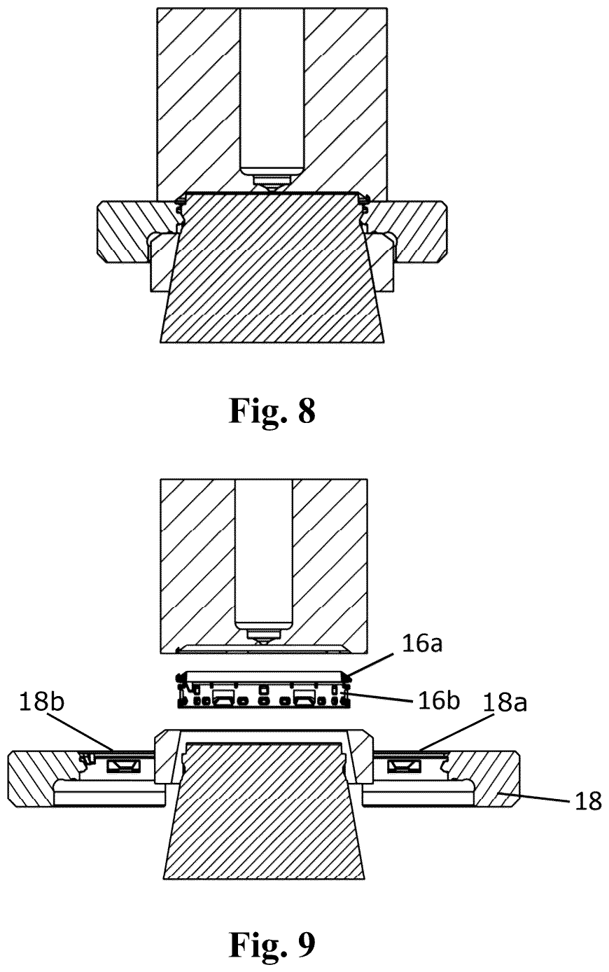

The production of the tamper-evident ring can be carried out with an injection molding tool according to FIGS. 8 and 9, which comprises radially movable casing tools 18 with radial pins/parts 18a, 18b to form the radially extending openings 16f.

FIG. 6 also shows the recess formed in the cover region of the closure cap 1, which recess contributes to the stability of the cap, and which is produced by the projection on the inner side of the casing tool.

After the injection molding according to FIG. 5, the unit consisting of the core inner part 2al and the first core sleeve 2a2 can be removed from the closure cap 1 by rotation according to the thread formation produced during injection molding. The closure cap 1 can be pushed away from the second core sleeve with the ejector sleeve 2a4. The closure cap 1 is unproblematically removed from the casing tool 2b.

The present invention is not limited to embodiments described herein; reference should be had to the appended claims.

### LIST OF REFERENCE NUMERALS

1 Closure cap
2 Injection molding tool
2a Core tool
2a1 Core inner part
2a2 First core sleeve
2a3 Second core sleeve
2a4 Ejector sleeve
2b Casing tool
3 Center axis
4 Volume region
5 Plastic
6 Axial end surface
6a Annular surface
7 Recess
8 Axial end surface
9 Projection
10 Insert element
10a Radially outer edge region
10b Edge
11 Gate opening
12 Annular surface
13 Annular projection
14 Channel
15 Reinforcing rib
16 Tamper-evident ring
16a Upper partial ring
16b Lower partial ring
16c Gap
16d Axially extending breakable bridges
16e Radially inwardly protruding projections
16f Radially extending openings
17 Annular gap
18 Casing tool
18a Part
18b Part

What is claimed is:

1-11. (canceled)

12. A method for producing a closure cap for a container, the method comprising:
providing an injection molding tool comprising at least one core tool and at least one casing tool which is configured to engage over the at least one core tool, each of the at least one core tool and the at least one casing tool being formed around a common center axis and, in a closed state of the injection molding tool, form between them a volume region which defines the closure cap, wherein,
the at least one core tool comprises an axial end surface in which a recess surrounding the center axis is formed,
the at least one casing tool comprises, on an inner axial end surface, a projection which surrounds the center axis,
the axial end surface of the at least one core tool and the inner axial end surface of the at least one casing tool are arranged mutually opposite to each other, and
the projection of the at least one casing tool comprises a gate opening;
positioning an insert element between the axial end surface of the at least one core tool and the inner axial end surface of the at least one casing tool;
closing the injection molding tool so that the projection of the at least one casing tool at least partially penetrates into the recess of the at least one core tool so as to thereby deform the insert element; and
after closing the injection molding tool, performing an injection molding by filling the volume region with a molten plastic through the gate opening positioned in the projection so that the insert element is pressed against the axial end surface of the at least one core tool by the molten plastic from a direction of the at least one casing tool.

13. The method as recited in claim 12, wherein the insert element is provided as a planar insert element and/or a circular disc-shaped insert element.

14. The method as recited in claim 12, wherein the gate opening is positioned on the center axis in the projection.

15. The method as recited in claim 12, wherein,
the insert element has a circular disc diameter which is selected so that, when the projection of the at least one casing tool at least partially penetrates into the recess of the at least one core tool and/or the insert element is pressed against the axial end surface of the at least one core tool by the molten plastic from the direction of the at least one casing tool, a radially outwardly facing edge surface of the insert element comes to lie on the axial end surface of the at least one core tool, or
the insert element has a circular disc diameter which is selected to be larger than an outside diameter of the axial end surface of the at least one core tool and the at least one core tool further comprises, in a lateral surface, an annular surface beyond which the lateral surface, in a cross section, tapers in a direction of the axial end surface, wherein, when closing the injection molding tool and/or due to the insert element being pressed against the axial end surface of the at least one core tool by the molten plastic from the direction of the at least one casing tool, a radially outer edge region of the insert element is turned over onto the lateral surface axially.

16. The method as recited in claim 15, wherein,
the circular disc diameter of the insert element is selected to be larger or smaller than,
an outside diameter of the axial end surface, or
an outside diameter of an annular surface of the axial end surface which surrounds the recess, or
an outside diameter of a regionally flat annular surface of the axial end surface, and
the radially outwardly facing edge surface of the insert element comes to lie on the axial end surface, on the annular surface of the axial end surface which surrounds the recess, or on the regionally flat annular surface of the axial end surface, or
the circular disc diameter of the insert element is selected to be larger than,
an outside diameter of an annular surface of the axial end surface which surrounds the recess, or
an outside diameter of a regionally flat annular surface of the axial end surface,
a diameter of the cross section of the annular surface of the at least one core tool tapers in the direction of the axial end surface of the at least one core tool, and
when closing the injection molding tool and/or due to the insert element being pressed against the axial end surface of the at least one core tool by the molten plastic from the direction of the at least one casing tool, so that the radially outer edge region of the insert element is turned over onto the lateral surface axially, a radially outwardly facing edge surface of the insert element, which is originally not-deformed, axially contacts, in the turned-over state, an annular projection of the at least one core tool which projects radially inwardly in the closure cap and which is formed by the molten plastic being molded onto the annular surface of the at least one core tool.

17. The method as recited in claim 12, wherein the insert element is selected from a material to which the molten plastic does not bond materially during the injection molding.

18. The method as recited in claim 17, wherein the insert element is held exclusively in a form-fitting manner and/or a force-fitting manner in the closure cap during the injection molding.

19. The method as recited in claim 17, wherein the material of the insert element is selected from a fluoropolymer, from polyethylene, or from polypropylene.

20. The method as recited in claim 19, wherein the fluoropolymer is perfluoroalkoxy, ethylene-tetrafluoroethylene, ethylene-chlorotrifluoroethylene, polyvinylidene fluoride, or polytetrafluoroethylene.

21. The method as recited in claim 12, wherein,
the axial end surface of the at least one casing tool comprises radially extending channels, and
reinforcing ribs are formed via the performing of the injection molding through the radially extending channels in a cover region and/or in a lateral region of the closure cap.

22. The method as recited in claim 21, wherein,
the at least one casing tool further comprises a radial lateral surface which comprises axially extending channels,
the radially extending channels and the axially extending channels are arranged to merge into one another, and
the reinforcing ribs are further formed via the performing of the injection molding through the radially extending channels and through the axially extending channels in the cover region and/or in the lateral region of the closure cap.

23. The method as recited in claim 12, further comprising, before closing the injection molding tool:
arranging a tamper-evident ring in two parts axially between the at least one core element and the at least one casing element,
wherein, following the performing of the injection molding,
the temper-evident ring is connected radially inwardly to the closure cap at a lower edge region surrounding a closure cap opening.

24. The method as recited in claim 23, wherein the temper-evident ring is connected radially inwardly to the closure cap at the lower edge region surrounding the closure cap opening in a form-fitting manner, in a force-fitting manner, and/or in a materially bonded manner.

25. The method as recited in claim 23, wherein,
the at least one core tool further comprises a core inner part which is coaxially surrounded by a first core sleeve, the first core sleeve being coaxially surrounded by a second core sleeve,
an annular gap which is open axially is formed between the first core sleeve and the second core sleeve, and
the tamper-evident ring is inserted into the annular gap at least with an axially extending partial region thereof.

26. The method as recited in claim 25, wherein,
the two parts of the tamper-evident ring are provided as a first partial ring and a second partial ring which are axially spaced apart via a gap and which are connected to each other axially in a gap-bridging manner via axially extending breakable bridges,
the first partial ring faces axially towards the axial end surface of the at least one casing tool and closes the annular gap between the first core sleeve and the second core sleeve against a penetration of the molten plastic, and
the first partial ring is connected to the molten plastic, after the molten plastic has been injected, with a surface which faces into the volume region of the injection molding tool.

27. The method as recited in claim 26, further comprising:
producing the tamper-evident ring prior to performing the injection molding.

28. The method as recited in claim 27, wherein the temper-evident ring and the closure cap are each produced of a same material.

29. The method as recited in claim 27, wherein, when producing the tamper-evident ring prior to performing the injection molding, forming radially inwardly extending projections and/or radially extending openings in the second partial ring which are shielded from the molten plastic.

30. The method as recited in claim 29, wherein the radially inwardly extending projections and/or the radially extending openings are formed in the second partial ring shielded from the molten plastic via an injection molding tool comprising a multi-part casing tool comprising parts which are movable in a radial direction.

31. A closure cap for containers which is produced via the method as recited in claim 12.
